(19) United States
(12) Patent Application Publication
(10) Pub. No.: US 2007/0048583 A1
(43) Pub. Date: Mar. 1, 2007

(54) Fuel cell

(76) Inventors: Shinsuke Andoh, Hitachi (JP); Osamu Kubota, Hitachi (JP); Kenichi Souma, Mito (JP); Kenji Date, Matsue (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/505,841

(22) Filed: Aug. 18, 2006

(30) Foreign Application Priority Data
Aug. 24, 2005 (JP) 2005-242508

(51) Int. Cl. H01M 8/02; H01M 8/10; H01M 4/86; H01M 8/24

(52) U.S. Cl. 429/34; 429/40; 429/30; 429/41; 429/38

(57) ABSTRACT

a fuel cell uses a liquid fuel and comprises an anode for oxidizing the fuel, a cathode for deoxidizing oxygen, and a proton-conductive solid polymer membrane interposed between the anode and the cathode. a fuel carrier is arranged so as to be in contact with one side of the anode; the one side is opposite to another side being in contact with the proton-conductive solid polymer membrane; the fuel carrier is configured to transport the fuel to the anode, allow the passage of carbon dioxide gas produced at the anode, and have a current-collecting function; and the fuel carrier is provided with an electrode terminal connector part.

### CLAIM OF PRIORITY

The present application claims priority from Japanese application serial no. 2005-242508, filed on Aug. 24, 2005, the content of which is hereby incorporated by reference into this application.

### BACKGROUND OF THE INVENTION

The present invention relates to a liquid fuel-using fuel cell, and more particularly to a solid polymer electrolyte fuel cell with a membrane electrode assembly (MEA).

As the recent electronics technology progresses, portable electronic equipment such as a mobile telephone, notebook-type personal computer, audio/visual equipment, camcoder, personal information terminal device, or the like has rapidly become widespread. The portable electronic equipment has been conventionally driven by a secondary battery. As high-energy density secondary batteries are developed, the secondary batteries have advanced from a seal lead battery to an Ni(nickel)-Cd(cadmium) battery, an Ni-hydrogen battery, and an Li(lithium) ion battery. These batteries aid in the miniaturization, weight reduction, and multi-function of the portable electronic equipment.

However these secondary batteries need to be charged as the power consumption increases. Accordingly, a battery charger and a relatively long charging time are required for them, especially in the case of long time continuous operation of portable electronic equipment at any time at any place.

In the portable electronic equipment, an information capacity thereof is increasing, and a high speed processing and multi-function versatility become more advanced. In order to meet with such circumstances, a power supply with a higher output power density and a higher energy density, namely a power supply usable continuously for a long time is required. Furthermore, A demand has been raised for a miniaturized generator that does not need a recharging, i.e., for a microgenerator that can easily replenish fuel.

According to such background, a fuel cell has received attention as a power supply usable for the portable electronic equipment. The fuel cell is composed of a solid or liquid electrolyte and two electrodes, i.e., anode and cathode, that induce desired electrochemical reaction. It is a generator that can directly convert a chemical energy owned by a fuel into an electric energy with high efficiency. Usable fuels include, in addition to hydrogen chemically converted from fossil fuel or water, methanol, alkalihydride, or hydrazine that is liquid or solution under a normal environment, and dimethylether or the like that is pressure-liquefied gas. Air or oxygen gas is used as oxidant gas. The fuel is electrochemically oxidized at the anode, while oxygen is deoxidized at the cathode, whereby the difference in the electric potential is produced between both electrodes. When a load is applied between both electrodes as an external circuit, the movement of ions is caused in the electrolyte, and hence, electric energy is taken out at the external load. Therefore, the fuel cell has been expected as a large-sized power generation system and a small-sized distributed cogeneration system as substitutes for thermal power generation devices, or has been expected as an electric vehicle power supply as a substitute for an engine generator. Accordingly, the development for putting the fuel cell into practical use has actively been made.

Among these fuel cells, attention has been paid to a direct methanol fuel cell (DMFC), a metal hydride cell and a hydrazine fuel cell as a compact portable supply or a mobile power supply, since these fuel cells use liquid fuel and hence the energy density per volume of the fuel is high. Among these fuel cells, a methanol-using DMFC can be said to be ideal electric power supply system because methanol is expected to be produced from biomass in the near future.

A polymer electrolyte membrane fuel cell (PEM-FC) generating system is generally composed of fuel cells, a fuel container, a fuel feeder, and an air or oxygen feeder. In this system, each of fuel cells is a fuel cell comprising a polymer electrolyte membrane, and a porous anode and a porous cathode respectively arranged on both sides of the electrolyte membrane. These fuel cells are connected to each other in series or in parallel. For the purpose of using the fuel cell such as DMFC using liquid fuel as an electric power supply for use in portable appliances, and of having a higher output power density of the fuel cell, efforts have been made to achieve high performance of an electrode catalyst, high performance of an electrode structure, and development for solid polymer membrane small in fuel crossover (the penetration of liquid through the membrane). Also for the same purpose, pursuit of ultimate technique for downsizing a fuel pump and an air blower for fuel cell is continued, and furthermore the use of a system requiring no auxiliary driving power such as the fuel pump and the air blower is studied.

U.S. Pat. No. 4,562,123 discloses a fuel cell that reduces auxiliary driving power or needs no auxiliary driving power. Furthermore, U.S. Pat. No. 4,562,123 discloses a power supply that needs no power for transporting liquid fuel to the fuel cell. Japanese Patent Laid-Open No. 2000-268835, Japanese Patent Laid-Open No. 2000-268836, Japanese Patent Laid-Open No. 2002-343378, Japanese Patent Laid-Open No. 2003-100315, and Non-Patent Document (S. R. Narayanan, T. I. Valdez, and F. Clara, Development of A Miniature Fuel Cell For Portable Applications, Electrochem., Soc., Proceedings, Vol. 2001-4, 254-264 (2001)) disclose a power supply that needs no power for transporting liquid fuel and oxidant gas.

In the portable fuel cell or the mobile fuel cell, it is desired that they can easily continue power generation by replenishing fuel, and they can use fuel whose energy density per volume is high. Further, it is desired to realize the fuel cell that do not need a separator to have less number of components, and that can feed fuel to an anode, without having an auxiliary fluid feeding machine, whatever posture of the fuel cell as a power supply.

### SUMMARY OF THE INVENTION

The present invention is to provide a fuel cell that can feed liquid fuel without having an auxiliary machine such as a fluid feeding machine, especially can feed fuel to an anode whatever posture of the fuel cell as a power supply, and that does not need a separator.

The present invention is a fuel cell that uses a liquid fuel and comprises an anode for oxidizing the fuel, a cathode for deoxidizing oxygen, and a proton-conductive solid polymer membrane interposed between the anode and the cathode; and a fuel carrier is arranged so as to be in contact with one side (one surface) of the anode; the one side is opposite to another side (another surface) being in contact with the proton-conductive solid polymer membrane; the fuel carrier is configured to transport the fuel to the anode, allow the passage of carbon dioxide gas produced at the anode, and have a current-collecting function; and the fuel carrier is provided with an electrode terminal connector part.

Further, the present invention is a fuel cell that uses a liquid fuel and comprises an anode, a cathode and a proton-conductive solid polymer membrane, which are as with the above-mentioned configuration, and a fuel chamber provided on the anode side; the fuel chamber is provided with a liquid fuel holding member for holding the fuel and transporting the fuel to the fuel carrier.

Further the present invention is a fuel cell that uses a liquid fuel and comprises an anode, a cathode and a proton-conductive solid polymer membrane, which are as with the above-mentioned configuration, and a fuel chamber provided on the anode side; and a part of the fuel carrier is arranged so as to extend into the inside of the fuel chamber.

### BRIEF DESCRIPTION OF THE DRAWINGS

FIG. 1 is a sectional view showing one embodiment of a fuel cell according to the present invention;

FIG. 2 is a sectional view showing other embodiment of a fuel cell according to the present invention;

FIG. 3 is a sectional view showing other embodiment of a fuel cell;

FIG. 4 is a sectional view showing other embodiment of the present invention;

FIGS. 5A to 5D are perspective views showing one example of a fuel carrier;

FIGS. 6A to 6C are perspective views showing another example of a fuel carrier;

FIGS. 7A and 7B are perspective views showing still another example of a fuel carrier;

FIG. 8 is a schematic structural view of a power supply system provided with the fuel cell of the present invention;

FIG. 9 is a perspective view showing the configuration of the fuel cell;

FIG. 10 is a perspective view showing an outer appearance of a fuel cell electric power supply equipped with a cartridge holder according to the present invention;

FIGS. 11A and 11B are a plan view and a sectional view, where FIG. 11A shows a plan view of a fuel chamber and FIG. 11B shows its sectional view taken along a line A-A;

FIGS. 12A and 12B are a plan view and a sectional view, where FIG. 12A shows a plan view of an anode terminal plate and FIG. 12B shows its sectional view taken along a line A-A;

FIGS. 13A to 13D show a perspective view and plan views, where FIG. 13A shows a perspective view of an anode current collector, and FIGS. 13B to 13D show plan views thereof;

FIG. 14 is a perspective view of a fuel cell provided with a power generating section at one side of the fuel chamber; and

FIG. 15 is a sectional view of the fuel cell.

### DESCRIPTION OF THE PREFERRED EMBODIMENT

In the embodiments of the present invention, plural unit cells having the aforesaid fuel carrier are arranged on at least one side of the fuel chamber, wherein the unit cells can be connected in series, in parallel, or in combination of series and parallel.

The fuel carrier may be configured such that the fuel and gas pass through the same flow path, but if possible, the fuel carrier is preferably configured to transport the fuel by a capillary power and to pass gas through relatively large pores on which the capillary power does not act. The fuel carrier of this type can be realized by providing two types of pores having average diameters different from each other; wherein the pores having small average diameter thereof are configured to transport the fuel with their capillary power; and the pores having large average diameter thereof are configured to allow the passage of the gas. The fuel carrier may comprise a porous structure composed of a skeletal part with pores capable of transporting the fuel by a capillary power and a gas path part with pores capable of allowing the passage of the gas.

The fuel carrier may be composed only of the porous structure through which the fuel and gas can flow, wherein a part thereof may be rendered to be an electrode terminal connector part. Alternately, the fuel carrier may be composed of a conductive frame having an electrode terminal connector part and a porous structure, wherein the porous structure is arranged inside the frame in order to electrically connect the frame and porous structure.

The fuel chamber desirably has a liquid fuel holding member. This liquid fuel holding member preferably holds and transports the fuel by a capillary power, whereby liquid spill can surely be prevented, and hence, the fuel cell is suitable for a portable power supply. In the case of the unit cell, the fuel carrier can be arranged as being in contact with the liquid fuel holding member. However, in the case of a fuel cell module (device) having plural unit cells arranged on one side of the fuel chamber, it is desirable that an electrically insulating porous structure is provided on the liquid fuel holding member in the fuel chamber, and the fuel carrier is arranged as being in contact with the electrically insulating porous structure. With this configuration, short circuit can be prevented.

An exhaust port for exhausting carbon dioxide gas produced at the anode can be formed at a part of the fuel chamber. In this case, the liquid fuel holding member needs to have gas permeability. The liquid fuel holding member is formed into a porous structure having small pores to which the capillary power acts and relatively large pores to which the capillary power does not act, like the fuel carrier, resulting in that the liquid fuel holding member can be provided with a fuel holding function and a gas transporting function.

Now, description will be made below on an embodiment in which methanol is used as liquid fuel, but the present invention is not limited by the embodiment to be described below.

A fuel cell, which uses methanol as liquid fuel, generates electric power by directly converting the chemical energy contained in methanol into electric energy through the following electrochemical reaction. In the anode, a fed methanol aqueous solution undergoes a reaction according to formula (1) to be dissociated into carbon dioxide gas, hydrogen ions and electrons.
CH₃OH+H₂O→CO₂+6H⁺+6e⁻ (1)

The produced hydrogen ions move in an electrolyte membrane from the anode to the cathode, and reacts with the oxygen gas from the air reaching the cathode by diffusion and electrons on the cathode according to formula (2) to produce water.
6H⁺+ 3/2O₂+6e⁻→3H₂O (2)

Consequently, as shown by formula (3), the total chemical reaction associated with the electric power generation produces carbon dioxide gas and water by oxidizing methanol with oxygen, and it has the same chemical reaction formula as that in the flame combustion of methanol.
CH₃OH+ 3/2O₂→CO₂+3H₂O (3)

The open-circuit voltage of the fuel cell per unit cell is approximately 1.2 V, but the substantial voltage is 0.85 to 1.0 V owing to the effect of the penetration of the fuel into the electrolyte membrane. Under practical load operation, the voltage is selected to range approximately from 0.2 to 0.6 V although no particular constraint is imposed on the voltage range. Consequently, when unit cells (fuel cells) are practically used as an electric power supply, the unit cells are connected in series so as to generate a predetermined voltage in conformity with the requirement from a load device. The output current density of the fuel cell per unit is affected by the electrode catalyst, the electrode structure and other factors and thereby varied; thus, each unit cell (fuel cell) is designed so that a predetermined current may be effectively obtained by selecting the area of the electric power generation section of the unit cell. Additionally, appropriate parallel connection of unit cells makes it possible to adjust battery capacity.

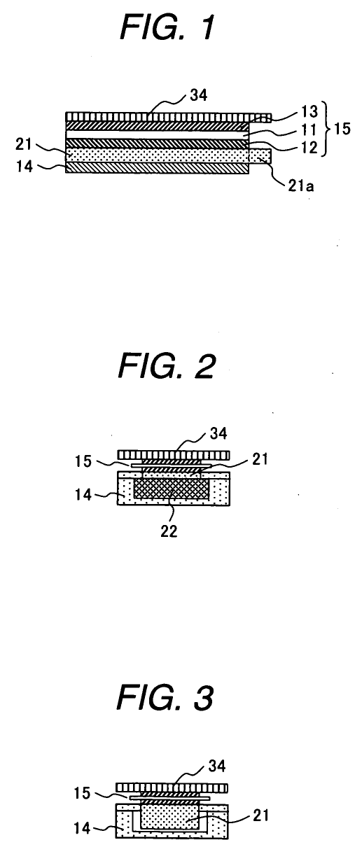

FIG. 1 shows a configuration of a unit cell (unit cell) according to this embodiment of the present invention. In FIG. 1, an anode 12 and a cathode 13 are arranged on opposite sides of a proton-conductive solid polymer membrane 11. A cathode current collector 34 is arranged on one side of the cathode 13, namely the one side opposite to another side being in contact with the proton-conductive solid polymer membrane 11. A fuel carrier 21 is arranged so as to be in contact with one side of the anode 12, namely the one side opposite to another side being in contact with the proton-conductive solid polymer membrane 11, and a fuel chamber 14 is arranged at its outside. The fuel carrier 21 has an electrode terminal connector part 21a at its side face. The anode 12, cathode 13 and proton-conductive solid polymer membrane 11 are integrally bonded to form an MEA 15.

The fuel carrier 21 in this embodiment has a porous structure. The porous structure is composed of small pores through which the fuel moves with a capillary power and relatively large pores through which gas passes. A skeletal part is formed with the small pores. In the fuel carrier having the aforesaid configuration, the fuel is transported through the skeletal portion having the capillary power, and gas passes through the relatively large pores on which the capillary power does not act. The fuel carrier 21 thus configured is arranged so as to be in direct contact with the liquid fuel in the fuel chamber for transporting the liquid fuel in the fuel chamber 14 to the anode 12 by capillary power, whereby an auxiliary machine such as a pump can be omitted. The fuel is transported by capillary power, resulting in that electric power can be generated without depending upon the posture of the power supply device. In the present invention, the fuel carrier also serves as a current-collecting member, so that the invention can eliminate a current-collecting plate to reduce the number of components.

Usable materials for the fuel carrier include a carbon plate; metal such as copper, nickel, aluminum, magnesium, or the like or their alloy; intermetallic compounds represented by copper-aluminum; or various stainless steels.

It is to be noted that the anode 12 has only a catalyst layer, or it sometimes has a catalyst layer and a conductive support member such as a carbon paper, cloth or the like. The present invention is applicable to both cases.

FIG. 2 shows another embodiment of the present invention. The different point from FIG. 1 is that the liquid fuel holding member is arranged in the fuel chamber 14. The liquid fuel holding member 22 desirably holds and transports the fuel by the capillary power. The combination of the liquid fuel holding member 22 and the fuel carrier 21 makes it possible to feed the fuel to the anode without causing the liquid spill under any posture, and further, to eliminate an auxiliary machine such as a pump.

FIG. 3 shows still another embodiment of the present invention. The different point from FIG. 1 is that the fuel carrier 21 is arranged so as to extend to the inside of the fuel chamber 14. The formation of small pores, on which the capillary power acts, as the fuel carrier 21 provides a fuel holding function thereto, whereby the fuel carrier 21 can be used as a liquid fuel carrier. Accordingly, the liquid fuel holding member 22 can be eliminated.

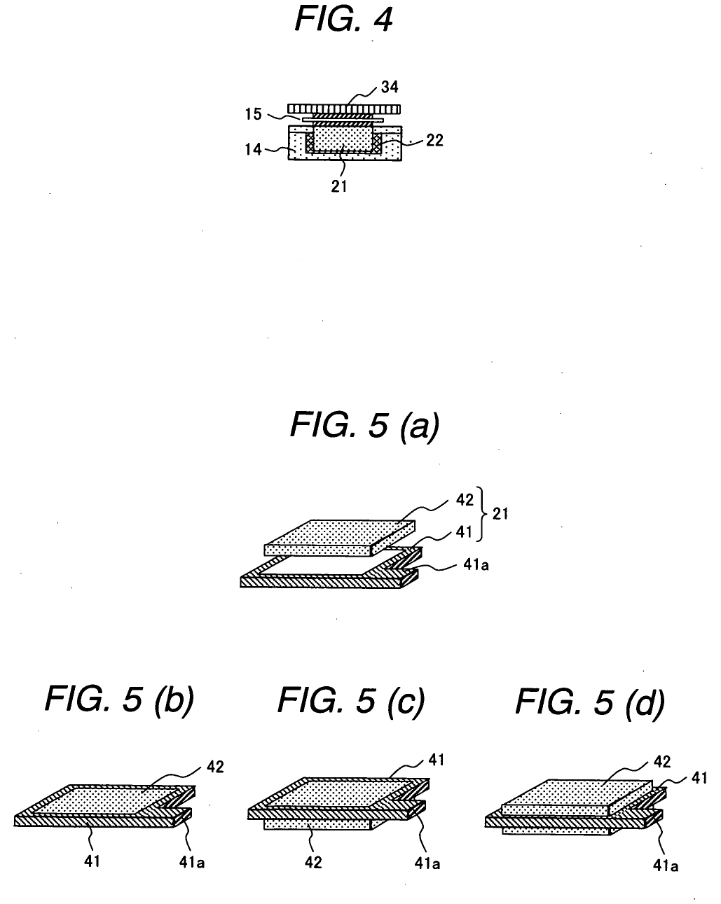

FIG. 4 shows still another embodiment of the present invention. The different point from FIG. 1 is that the fuel carrier 21 is arranged so as to extend to the inside of the fuel chamber 14 and the liquid fuel holding member 22 is arranged inside the fuel chamber 14. This configuration also makes it possible to feed the fuel to the anode under any posture, and further, to eliminate an auxiliary machine such as a pump.

In FIGS. 2 to 4, the gas produced at the anode 12 is exhausted to the outside of the battery (fuel cells: power supply device) through the fuel carrier 21. A gas exhaust port can be provided at the fuel chamber 14 for exhausting the gas through the liquid fuel holding member 22.

In case where the fuel carrier 21 and the liquid fuel holding member 22 are both used, it is necessary to set the capillary power of the fuel carrier to be greater than the capillary power of the liquid fuel holding member. If the capillary power of the fuel carrier is smaller than the capillary power of the liquid fuel holding member, the fuel cannot be fed from the liquid fuel holding member to the fuel carrier.

The embodiments shown in FIGS. 1 to 4 is the following great feature: the porous structure has two types of pores that are small pores for transporting the fuel by capillary power and relatively great pores on which the capillary power does not act and through which only gas passes; and

the porous structure is arranged at the space from the fuel chamber to the anode of the MEA, wherein the fuel is fed to the anode by capillary power. Accordingly, the fuel can be fed to the anode of the MEA without depending upon the posture of the battery (fuel cells). Further, carbon dioxide gas produced at the anode with the power generation passes through the relatively great pores of the porous structure and exhausted, so that the hindrance of the fuel feeding due to the stay of air bubbles can be prevented, and hence, high power generating property can be maintained. The porous structure has at least two types of pores each having different diameter and each being generally uniformly dispersed on the porous structure. Thereby the liquid fuel moves through the small-diameter pores by capillary power and carbon dioxide gas moves through the large-diameter pores. Accordingly, a great effect can be provided for the stability in the fuel feeding to the anode and the exhaustion of carbon dioxide gas.

It is desirable that the surface of the porous structure, which serves as the fuel carrier, is rendered as hydrophilicity by chemical processing or by dispersing and supporting a hydrophilic material represented by titanium oxide on the surface thereof. With this, carbon dioxide gas produced by the electric power generation rapidly can move without adhering or staying in the vicinity of the anode.

The case, in which the fuel carrier is composed of a conductive frame 41 with an electrode terminal connector part 41a and a porous structure with a flow path capable of passing a fuel and gas thorough, will be explained with reference to FIGS. 5A to 5D. FIG. 5A shows the state where the porous structure 42 is not yet fitted to the frame 41. An electrode terminal connector part 41a is provided at the side face of the frame 41. FIG. 5B shows the case where the thickness of the porous structure 42 and the thickness of the frame 41 are equal to each other. FIG. 5C shows the case where the porous structure 42 is thicker than the frame 41, so that the porous structure 42 sticks out of the frame 41 downwardly. FIG. 5D shows the case where the porous structure 42 sticks out of the frame 41 both upwardly and downwardly.

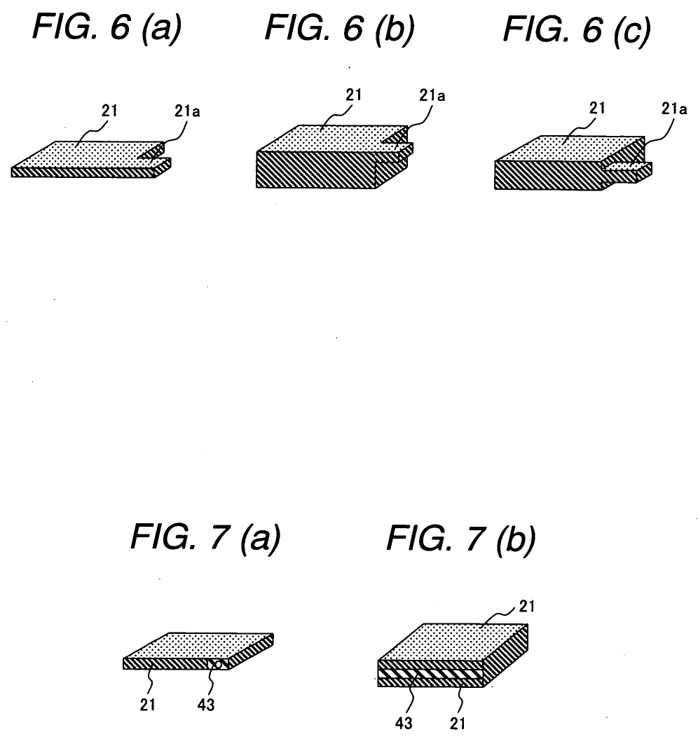

The case, in which the fuel carrier is composed only of the porous structure and the electrode terminal connector part is provided at a part thereof, will be explained with reference to FIGS. 6A to 6C. FIG. 6A shows the case in which the electrode terminal connector part 21a is provided at the side face of the fuel carrier 21 composed of the porous structure. FIG. 6B shows the case in which the electrode terminal connector part is provided at the upper portion of the side face of the porous structure. FIG. 6C shows the case in which the electrode terminal connector part is provided at the central part of the side face of the porous structure. The fuel carriers shown in FIGS. 6A to 6C have a merit of reducing the number of components compared to those shown in FIGS. 5A to 5D.

The case, in which the electrode terminal connector part separately being manufactured from the fuel carrier is mounted to a part of the fuel carrier composed of the porous structure, will be explained with reference to FIGS. 7A and 7B. FIG. 7A shows the case in which an electrode terminal connector part 43 is mounted to the side face of the porous structure, wherein a terminal connecting hole is formed at the electrode terminal connector part. FIG. 7B shows the case in which a pair of fuel carriers 21 composed of the porous structures are provided so as to sandwich the electrode terminal connector part 43.

No particular constraint is imposed on the shape of the fuel carrier and the position where the electrode terminal connector part is mounted, i.e., they are optional.

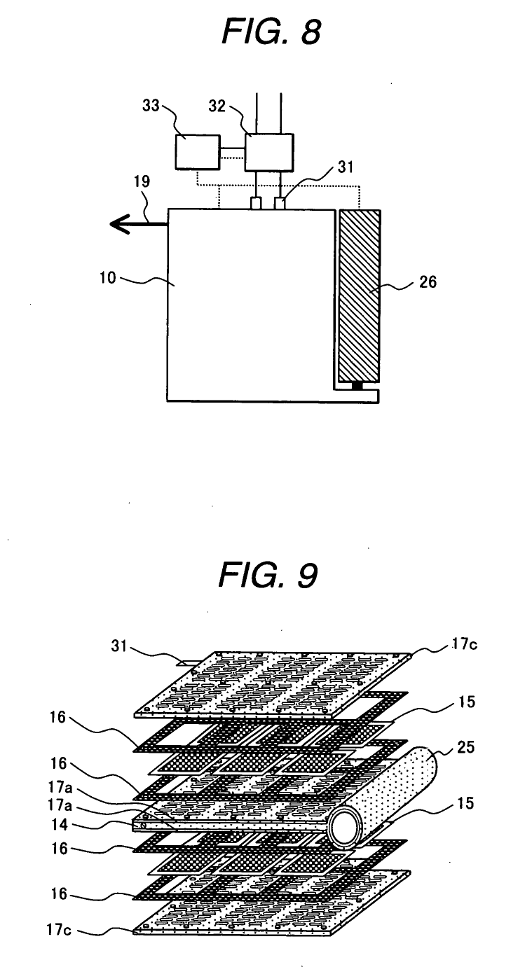

FIG. 8 shows a configuration of a power supply system provided with the fuel cell according to the present invention. This power supply system is composed of a fuel cell module 10 comprised of a plurality of fuel cells, a fuel cartridge tank 26, an output terminal 31, a hole for exhausting an exhaust gas 19, a DC/DC converter 32, and a controller 33. The fuel cartridge tank 26 is detachable to the fuel cell module 10. As electric power is generated, the fuel in the fuel chamber is consumed, and the fuel is replenished from the fuel cartridge tank 26 to the fuel chamber. The fuel cell-output power is supplied to load equipment through the DC/DC converter 32. The DC/DC converter 32 is controlled by the controller 33 on the basis of the signals indicating the conditions of the fuel cell module 10, the remaining fuel amount in the fuel cartridge tank 26, and the conditions during driving and stop of the DC/DC converter 32. The controller 33 can be set to output alarm signals according to need, and additionally, the controller 33 can, if necessary, indicate on the load equipment the operation conditions of the power supply including the fuel cell-voltage, the output current and the fuel cell-temperature. For example, when the remaining amount in the fuel cartridge tank 26 comes to be smaller than a predetermined amount, or when the air diffusion amount deviates from a predetermined value, the supply of the electric power from the DC/DC converter 32 to the load equipment is stopped, and simultaneously an alarm such as a sound signal, a voice signal, a pilot lamp or a character display etc. is issued. Additionally, it is possible to be configured so that, when the operation is normal, the load equipment takes in the fuel remaining amount signal from the fuel cartridge tank 26 and displayed the fuel remaining amount on the load equipment.

FIG. 9 is a perspective view showing the component configuration of a fuel cell module. An anode terminal plate 17a, a gasket 16, MEAs 15, a gasket 16, and a cathode plate 17c are stacked in this order on one side of the fuel chamber 14 equipped with a fuel cartridge holder 25. Stacked on the other side of the fuel chamber 12 is also composed of the anode terminal plate 17a, gasket 16, MEAs 15, gasket 16 and cathode plate 17c in this order. The stack thus obtained is integrally fixed with screws so as for the in-plane compression force to be approximately even. Thus, the fuel cell module 10 is assembled.

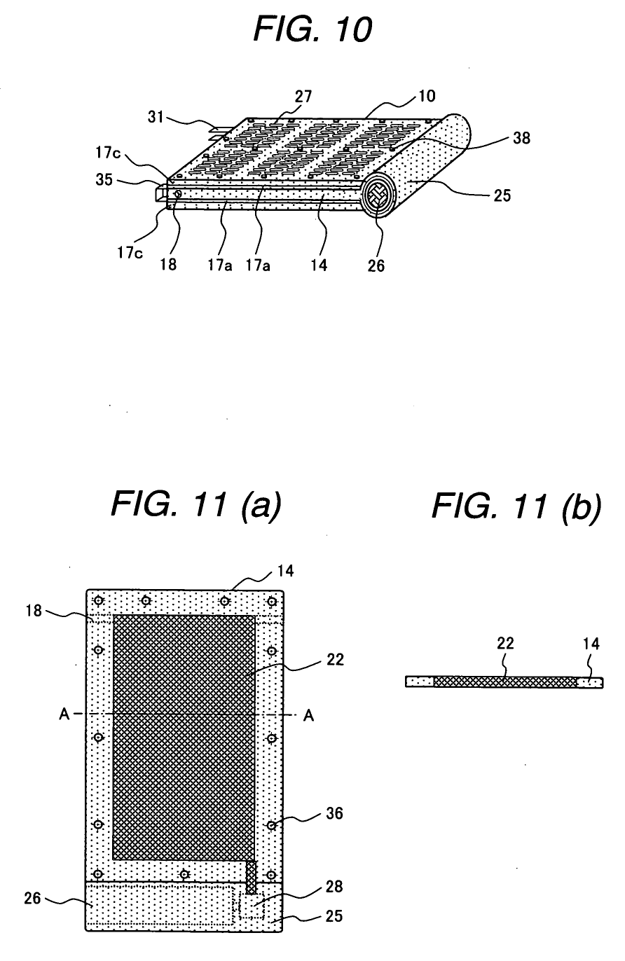

FIG. 10 illustrates a perspective view showing an outer appearance of the fuel cell devise 10 having an electric power generation section on each of both sides of the fuel chamber. The fuel cell module 10 has a structure in which a plurality of unit cells (fuel cells) are connected in series on each of both sides of the fuel chamber 14, the groups of the serial unit cells on the above described two sides are further connected in series with a connection terminal 35, and the electric power is taken out from an output power terminal 31. The fuel is fed from the fuel cartridge tank 26 to the fuel chamber 14. In case where the unit cell is configured as shown in FIG. 2 and the exhaust port 18 is provided at the fuel chamber 14. Carbon dioxide gas produced at the anode moves through the fuel carrier 21 and the fuel holding member 22, and then, exhausted to the outside of the fuel cell module through the exhaust port 18. On the other hand, air as an oxidant is fed by diffusion from an air diffusion slit 27, and the water produced in the cathode diffuses to be discharged from the air diffusion slit 27. The battery is integrated by tightening with the screw 38.

A tightening method for assembling unit cells (fuel cells) into a single module is not limited to a method using screws as disclosed in the present example; examples of the tightening method include a method in which the single module for unit cells can be achieved by inserting the fuel cells in a cabinet so as for the fuel cells to undergo compression by the compressive force exerted by the cabinet. Another method may also be employed.

FIGS. 11A and 11B show the structure of the fuel chamber 14, in which 11A is a plan view and 11B is a sectional view taken along a line A-A. In this embodiment, the liquid fuel holding member 22 is arranged in the fuel chamber 14. The fuel chamber 14 is provided with the exhaust port 18, screw holes 36 for tightening the fuel cells, a socket 28 for the fuel cartridge tank, and a fuel cartridge holder 25. The material of the liquid fuel holding member 22 is not particularly constrained as long as the material is flat such that even contact pressure is applied when MEAs are mounted, and the material can provide a structure in which a plurality of cells arranged on the plane of the material are insulated so as not to be short-circuited. Usable materials for the liquid fuel holding member 22 include various metal oxides such as ceramics, metals such as carbon plates, steel, nickel, aluminum or magnesium, alloy materials thereof, intermetallic compounds represented by copper-aluminum, or various stainless steels. Further, a method in which the surface of the conductive material is made nonconductive and a method in which the surface of the conductive material is made to be insulating by applying resins onto the surface, can be adopt. A stack structure may be employed with the electrically insulating material.

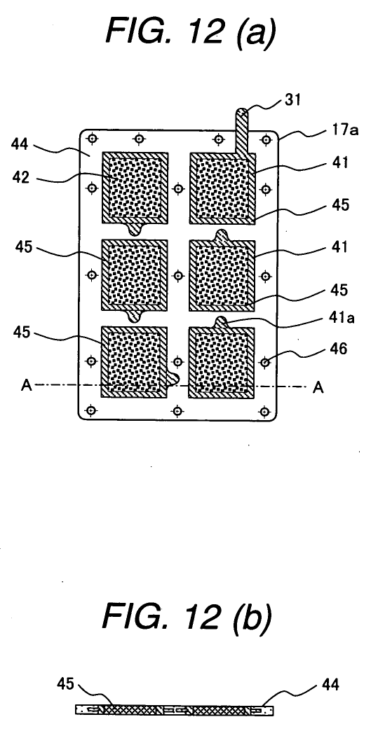

FIGS. 12A and 12B show the structure of the anode terminal plate 17a bonded to the fuel chamber. FIG. 12A is a plan view, while FIG. 12B is a sectional view taken along a line A-A. The anode terminal plate 17a has six unit cells on one side thereof. It also has three types of anode current collectors 45 with electron conductivity and corrosive resistant. The anode terminal plate, unit cells, and anode current collectors are integrated with and bonded to an insulating sheet 44 to electrically connect the six unit cells in series. A plurality of screw holes 46 are arranged on the insulating sheet 44 for the purpose of integrating and tightening fuel cell module components. Each of the anode current collectors 45 is composed of the fuel carrier according to the present invention. Specifically, it is composed of the porous structure 42 with a flow path through which fuel and gas can flow and the frame 41 with the electrode terminal connector part 41b. The output terminal 31 is provided at one of the six anode current collectors. No particular constraint is imposed on the materials to be used for the porous structure. Usable materials for the porous structure include materials that are substantially electrochemically inert, such as carbon porous base material, stainless steel fiber non-woven fabric, or porous material such as porous titanium or porous tantalum. Moreover, in the frame provided with the electrode terminal connector part, it is preferable to plate the electrode terminal connector part with corrosion resistant noble metals such as gold, or to apply a coating of conductive carbon paint to the electrode terminal connector part. Such ways are effective to reduce the contact resistance of the current collector in mounting, thereby to ensure the improvement of the output power density and the long term stability of the fuel cell module.

No particular constraint is imposed on the insulating sheet 44 for the anode terminal plate 17a as long as the insulating sheet is a material with which the current collectors 45 in the surface of the sheet can be integrally bonded with the sheet in a manner of ensuring insulating property and planarity of the sheet. It is recommended to use high density vinyl chloride, high density polyethylene, high density polypropylene, epoxy resin, polyetheretherketones, polyethersulfones, polycarbonate, polyimide resin, and glass fiber reinforced materials derived from these materials. Additionally, metals such as steel, nickel, aluminum or magnesium or alloy materials thereof, or various stainless steels are used to make the surface nonconductive or make the surface to be insulating by applying resins onto the surface.

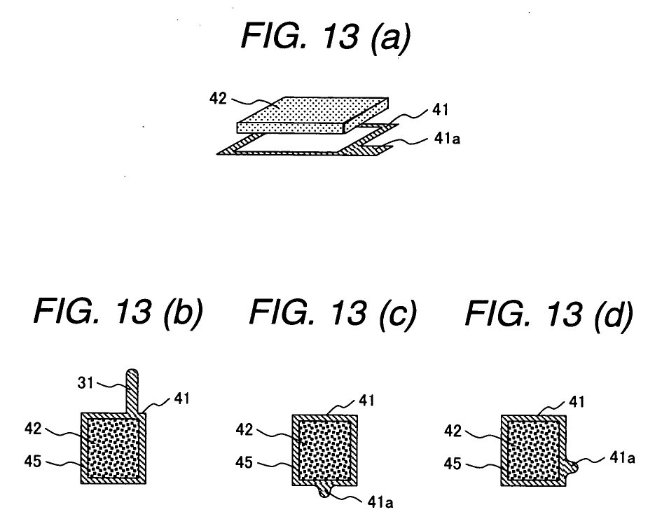

FIGS. 13A, 13B, 13C and 13D show examples of the anode current collectors bonded to the anode terminal plate 17a. The structure of the anode current collector 45 is basically the same as that of the fuel carrier shown in FIG. 5B. The output terminal 31 of the fuel cell module is provided at the anode current collector shown in FIG. 13B.

[Concrete Application Example 1 of Those Embodiments]

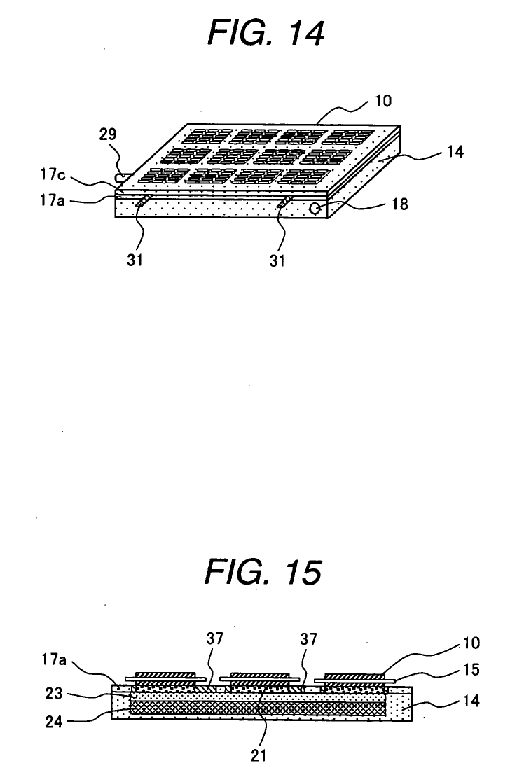

A DMFC for use in a portable information terminal to which the invention is applied will be described below. FIG. 14 shows a perspective view of an outer appearance of the DMFC. The fuel cell 10 includes the fuel chamber 14, MEAs not shown in the figure, and a cathode terminal plate 17c and an anode terminal plate 17a sandwiching a gasket therebetween. The electric power generation section is mounted only on one side of the fuel chamber 14. On the outer periphery of the fuel chamber 14, a fuel feeding pipe 29 and an exhaust gas port 18 are arranged. Additionally, a pair of output power terminals 31 is arranged on the outer periphery of the anode terminal plate 17a and the cathode terminal plate 17c. The assembled structure of the cell module is the same as the component configuration illustrated in FIG. 9 except that the electric power generation section is mounted only on one side of the fuel camber 14 and the fuel cartridge holder is not integrated. The sectional structure of this fuel cell is shown in FIG. 15. The conductive fuel carrier 21 is provided as being in contact with the anode, and the fuel carrier 21 is brought into contact with an interconnector 37. An electrically insulating cellulose porous structure 23 and metallic porous structure 24 are arranged in the fuel chamber 14. The short circuit of the unit cell can be prevented by the insulating cellulose porous structure 23. The materials used are high density vinyl chloride resin for the fuel chamber, a polyimide resin film for the anode terminal plate, and a glass fiber reinforced epoxy resin for the cathode terminal plate. SUS316L is used for the metallic porous structure, and the cellulose porous structure is made of cellulose pulp fiber. The fuel cell devise having the above-mentioned configuration and having a power supply with the size of 115 mm×90 mm×9 mm was fabricated. A 30 wt % methanol aqueous solution was injected into the fuel chamber 12 of the fuel cell thus fabricated, an electric power generation test was carried out at room temperature, and the resulting output power was represented by 4.2 V and 1.2 W.

According to the above-mentioned embodiments, a power generator using this type of the fuel cell can omit a separator, and further, can generate power without depending upon the posture of the device, with the result that it is suitable for a power supply for portable electronic equipment.

What is claimed is:

1. A fuel cell that uses a liquid fuel and comprises an anode for oxidizing the fuel, a cathode for deoxidizing oxygen, and a proton-conductive solid polymer membrane interposed between said anode and said cathode,
wherein a fuel carrier is arranged so as to be in contact with one side of said anode, said one side is opposite to another side being in contact with said proton-conductive solid polymer membrane, and said fuel carrier is configured to transport the fuel to said anode, allow the passage of carbon dioxide gas produced at said anode, and have a current-collecting function,
wherein said fuel carrier is provided with an electrode terminal connector part.

2. A fuel cell according to claim 1,
wherein said fuel carrier has two types of pores having average diameters different from each other, and
wherein the pores having small average diameter thereof are configured to transport the fuel with their capillary power, and the pores having large average diameter thereof are configured to allow the passage of the gas.

3. A fuel cell according to claim 1, wherein the fuel carrier comprises a porous structure composed of a skeletal part with pores capable of transporting the fuel by a capillary power and a gas path part with pores capable of allowing the passage of the gas.

4. A fuel cell according to claim 1, wherein the fuel carrier comprises a frame with an electrode terminal connector part, and a porous structure arranged inside the frame and configured to allow each passage of the fuel and gas,
wherein the frame and the porous structure are electrically connected to each other.

5. A fuel cell according to claim 4, wherein the porous structure has pores for transporting the fuel by a capillary power and other pores for allowing the passage of the gas.

6. A fuel cell according to claim 1, wherein said electrode terminal connector part is provided at the side face of the fuel carrier.

7. A fuel cell according to claim 1, said fuel cell comprises a plurality of unit cells arranged on at least one face of the fuel chamber, wherein each of unit cells are electrically connected in series, electrically connected in parallel, or electrically connected in combination with series and parallel.

8. A fuel cell according to claim 7, wherein said fuel chamber is provided with a carbon dioxide gas exhaust port.

9. A fuel cell according to claim 7, wherein said fuel chamber is provided with a liquid fuel holding member.

10. A fuel cell according to claim 9, wherein said liquid fuel holding member is configured to hold and transport the fuel to the fuel carrier by a capillary power.

11. A fuel cell according to claim 7,
wherein said fuel chamber is provided with a liquid fuel holding member and an electrically insulating porous structure with a fuel transporting function,
wherein the said carrier is arranged to be in contact with said electrically insulating porous structure.

12. A fuel cell that uses a liquid fuel and comprises an anode for oxidizing the fuel, a cathode for deoxidizing oxygen, a proton-conductive solid polymer membrane interposed between said anode and said cathode, and a fuel chamber provided on the anode side,
wherein a fuel carrier is arranged so as to be in contact with one side of said anode, said one side is opposite to another side being in contact with said proton-conductive solid polymer membrane, and said fuel carrier is configured to transport the fuel to said anode, allow the passage of carbon dioxide gas produced at the anode, and have a current-collecting function,
wherein said fuel carrier is provided with an electrode terminal connector part,
wherein said fuel chamber is provided with a liquid fuel holding member for holding the fuel and transporting the fuel to said fuel carrier.

13. A fuel cell according to claim 12, wherein said liquid fuel holding member is configured to hold the fuel and transport the fuel by its capillary power.

14. A fuel cell according to claim 12, wherein a part of said fuel carrier is arranged so as to extend into the inside of said fuel chamber.

15. A fuel cell that uses a liquid fuel and comprises an anode for oxidizing the fuel, a cathode for deoxidizing oxygen, a proton-conductive solid polymer membrane interposed between said anode and said cathode, and a fuel chamber provided on the anode side,
wherein a fuel carrier is arranged so as to be in contact with one side of said anode, said one side is opposite to another side being in contact with said proton-conductive solid polymer membrane, and said fuel carrier is configured to transport the fuel to said anode, allow the passage of carbon dioxide gas produced at said anode, and have a current-collecting function,
wherein said fuel carrier is provided with an electrode terminal connector part,
wherein a part of said fuel carrier is arranged so as to extend into said fuel chamber.

16. A fuel cell according to claim 15, wherein said fuel carrier is configured to hold the fuel and transport the fuel to the anode by its capillary power.
